(19) United States
(12) Patent Application Publication
(10) Pub. No.: US 2009/0074613 A1
(43) Pub. Date: Mar. 19, 2009

(54) APPARATUS FOR DISTINGUISHING BETWEEN AIRCRAFT CONSUMABLES

(76) Inventors: Peter Kaindl, Wien (AT); Nicole Dorr, Wien (AT); Attila Agoston, Wien (AT)

Correspondence Address: Workman Nydegger;1000 Eagle Gate Tower, 60 East South Temple, Salt Lake City, UT, 84111, US

(21) Appl. No.: 12/093,276

(22) PCT Filed: Nov. 8, 2006
(86) PCT No.: PCT/AT2006/000456

§ 371 Date: Oct. 6, 2008

(30) Foreign Application Priority Data
Nov. 9, 2005 (AT) A 1832/2005

(51) Int. Cl. G01N 21/78; B01J 19/00; G01N 21/75

(52) U.S. Cl. 422/57; 422/68.1; 422/82.05

(57) ABSTRACT

A device (1, 1′) for distinguishing between aircraft consumables (2) is portable and preferably designed as a handset and comprises at least one detection unit (6A-6G, 22) designed for detecting at least one aircraft consumable (2), the aircraft consumables comprising fuel, de-icing fluid, turbine oil, hydraulic oil, pneumatic oil and/or propeller grease for adjustable rotor blades and lubricating greases. The differentiation can occur in a quick test and on site.

The invention relates to a device for distinguishing between aircraft consumables according to the preamble of claim 1.

The invention aims at reliably distinguishing between consumables used in aircraft, such as aircraft fuels and aircraft lubricants, as well as consumables to be applied on the outside of an aircraft. Seven different products from a liquid to a highly viscous consistency are used for the operation of aircraft. These products are substance mixtures of different compositions:
1) kerosene
2) turbine oil
3) hydraulic oil
4) pneumatic oil (mostly based on a hydraulic oil but with a different consistency)
5) 1. lubricating grease (e.g. propeller grease)
6) 2. lubricating grease (e.g. based on graphite, molybdenum disulfide)
7) de-icing fluid as a consumable to be applied on the outside of an aircraft.

In case of leakages, it is essential for safety reasons to determine the type of consumable that is leaking in order to decide upon the take-off of an aircraft based thereupon. Therefore, if a pilot discovers traces of leaked consumables during the mandatory inspection of his aircraft prior to take-off, it is imperatively regulated in civil aviation that the cause of this leakage of a consumable be clarified before such an aircraft may take off. At present, the discovery of a consumable leaked from an aircraft involves an extremely time-consuming process, since the pilot must contact the tower and/or the technical services at the airport, whereupon a technician will be sent to the location of the aircraft who will determine the cause of the leaked consumable at the aircraft. Depending on the type of consumable that has leaked, no objections are raised against performing the flight after the cause has been determined, for example, if only a few drops of kerosene spilled over during refuelling of the aircraft, or if de-icing fluid dripped down during de-icing of the wings. If, however, other consumables such as, e.g., hydraulic oil are leaking, a repair of the aircraft must normally be carried out.

From the point of view of an airline operator, fast identification and optionally fast clearance of the aircraft are of great financial interest, since the airport fees accumulating due to delays constitute substantial financial damage. The identification of a leaking consumable within a couple of minutes could thus bring about a significant cost saving. An accelerated identification of a leaking consumable would also hamper the airport operation to a lesser extent. The conditions encountered on airports require that the measurement be performable without a large effort also by flight personnel who usually are not trained in chemical/physical analytics.

Although it is possible to detect all the above-mentioned aircraft consumables in chemical-analytical laboratories, partly, however, by using expensive instruments, so far no device has existed with which a differentiation of leaked aircraft consumables is possible on site. Rather, the summoned aircraft technician identifies the consumable to be examined either based on his experience by visual inspection (colour, smell, consistency etc.), which, however, constitutes a potential safety risk and also a health risk for the aircraft technician (some consumables are corrosive), or he determines the origin of the consumable by locating the leakage point on the aircraft, which, however, may be very time-consuming. It would therefore be highly desirable if the pilot himself had a device for distinguishing between aircraft consumables at hand, which would enable him to identify a leaked aircraft consumable and thereby to reach an objective decision as to whether the leaked consumable points to a safety risk as a result of a technical defect and hence the tower and/or an aircraft technician must be notified, or whether the leaked consumable is completely harmless for the performance of the flight, e.g., because it is merely kerosene spilled over during refuelling or de-icing fluid.

Therefore, it is the object of the present invention to provide a device for distinguishing between aircraft consumables, by means of which the above-illustrated air traffic problems are solved.

The problem posed is solved by a device for distinguishing between aircraft consumables having the characterizing features of claim 1. Advantageous embodiments of the invention are set forth in the dependent claims.

The device according to the invention for distinguishing between aircraft consumables is portable and preferably designed as a handset. It comprises at least one detection unit designed for detecting at least one aircraft consumable, the aircraft consumables comprising fuel, de-icing fluid, turbine oil, hydraulic oil, pneumatic oil and/or propeller grease for adjustable rotor blades and lubricating greases. In a particularly preferred embodiment, the device according to the invention is designed as a quick-test device which provides the result of the differentiation of aircraft consumables on site.

The present invention provides the major advantage that the pilot of an aircraft is enabled to identify on his own aircraft consumables leaked from his aircraft to such an extent that he will be able to reach a basic decision as to whether the performance of the flight is absolutely safe or whether a precise examination of the cause of the leakage of the consumable must be performed on the aircraft by a technician. In many cases, it is not necessary to send for a technician, whereby a delay in departure is not caused, either. The invention thereby contributes to the fact that significant expenses are saved for aircraft operators, the air traffic is not hampered and a high feeling of safety is preserved for the passengers. The invention ensures easy and faultless handling by the pilot or the ground personnel. It is not necessary to experiment with chemicals, syringes, different containers etc., which, for safety or space reasons, probably may not be taken on an aircraft anyway.

A further advantage of the device according to the invention is that the duration until a consumable is detected is short. The selective detection of consumables to be considered may take place in different detection units, whereby no mutual interference with the analytical reactions will occur. As a result, the analytical reactions of the individual consumables suitably provide an EXISTENT/INEXISTENT differentiation, quantity measurements are not required for the purposes of the invention.

In one embodiment of the invention, an intake area for receiving a sample of the aircraft consumable to be examined is provided. Said intake area forwards the sample of aircraft consumable to the detection units. This is conveniently effected by capillaries or vacuum conduits, wherein the conduits are evacuated, for example, already during a process of manufacturing the device and are sealed by protective strips (attached to an opening of the intake area), a demolishable wall, etc., and, for the purpose of suction, the user of the device according to the invention only has to remove the protective strip during startup or has to bend the sealing wall at a predetermined breaking point or the like so that the consumable can be sucked in.

According to a basic concept of the invention, at least one detection unit is based on colour-chemical reactions to aircraft consumables. In a compact, operationally reliable embodiment of the invention, the detection unit comprises a carrier impregnated with at least one substance which produces a colour-chemical analytical reaction upon contact with an aircraft consumable, with the carrier optionally being applied to an inert substrate or at least another carrier impregnated with a said substance so that several different aircraft consumables can be detected in one detection process. The highest possible compactness, the lowest possible weight and thus optimum suitability for air traffic are achieved if the detection unit is designed as a test strip. The test strip is small and therefore easily archivable, for example, in the aircraft so that longer surveillance and analysis of looming technical problems are rendered possible. Furthermore, the test strip can be transported absolutely safely, since it does not contain any chemicals which might leak. For activating the test strip, it simply can be dipped into the consumable to be examined, whereby the analytical reaction is initiated.

The colour-chemical analytical reactions of the aircraft consumables in the detection units are preferably chosen such that they are immediately visually noticeable to the user or provide analyzable results via an optical, in particular optoelectronic, detector embedded in the device according to the invention or coupled thereto, respectively. The advantage of an evaluation using a detector is the objectification of the discrimination results, which is of utmost interest also for the pilot with regard to his legal safeguarding and liability issues. The result of the evaluation can be recorded in connection with an evaluation and control unit, for which purpose the device is suitably equipped with a nonvolatile data memory in which the detection results, preferably supplemented by time and date information as well as optionally by identification information about the aircraft and/or the pilot, are filed.

A leaked aircraft consumable which very often can be found underneath an aircraft is glycol-containing de-icing fluid. The leakage of said de-icing fluid is aeronautically harmless so that the aircraft will not have to be inspected by a technician, provided that the pilot is sure that said fluid is indeed involved. For that reason, in a preferred embodiment of the invention, at least one detection unit is designed for the detection of glycol-containing de-icing fluid. In an embodiment which operates fast and does not contain any dangerous chemicals, said detection unit comprises an oxidation zone preferably impregnated with sodium periodate, potassium periodate, sodium dichromate or potassium dichromate, an alkalization zone preferably exhibiting caustic soda or caustic potash solution, and a detection zone with commercially available Purpald®, which is a registered trademark of Aldrich Chemical Co., Inc. The substance sold under the name Purpald® is 4-amino-3-hydrazino-5-mercapto-1,2,4-triazole (C₂H₆N₆S). The glycol is broken down in the oxidation zone, whereby formaldehyde is formed, and subsequently is rendered alkaline in the alkalization zone. The Purpald® in the detection zone reacts to the produced formaldehyde by turning purple, which can easily be detected by the user of the device.

According to a further basic concept of the invention, the detection unit comprises infrared sensors for distinguishing between aircraft consumables, wherein the detection of aircraft consumables using infrared sensors can be combined with the detection of aircraft consumables via chemical colour reactions, either to the effect that one group of consumables is detected by infrared sensors and another group of consumables is detected by colour-chemical reactions, or to the effect that one consumable is at first detected preliminarily by one of the two methods and the preliminary detection result is confirmed by the other detection method.

Examinations performed by the inventors with a laboratory infrared spectrometer have shown that a differentiation of the aircraft consumables to be distinguished on the basis of their infrared spectra is basically possible. Each consumable is characterized by a specific infrared spectrum due to the different compositions, whereby a differentiation between the individual consumables is possible. The distinguishing features appear in characteristic ranges of the infrared spectrum. It is therefore possible to distinguish between the consumables on the basis of selected infrared spectral ranges without having to be aware of the entire infrared spectrum of the consumables. It is an advantage of the present invention that a significantly faster and simpler determination of the consumables to be identified and distinguished, respectively, can be realized as compared to current analytical methods.

The design of the infrared sensors in a portable device (preferably in the version as a handset), as illustrated below, allows on-site analysis of the aircraft consumables.

The infrared sensors in the device according to the invention comprise an infrared source, an infrared detector and a consumable sample interface arranged in the optical path between the infrared source and the infrared detector, with the infrared source radiating broadband infrared light onto the sample interface and the infrared detector detecting the infrared light after interaction with the consumable sample. So as to detect subranges of the infrared spectrum which are characteristic of the consumables, it is furthermore provided that infrared spectral filters are switchable into the optical path between the infrared source and the sample interface. In order to further reduce the overall size of the device according to the invention, in one embodiment of the invention, the infrared spectral filters are sequentially switchable into the optical path, with an evaluation and control unit being provided for control and evaluation, which switches the infrared spectral filters with filter frequency ranges according to the characteristic partial spectral ranges into the optical path and, in each case, evaluates the partial spectrum received by the infrared detector. For the evaluation, the measured values for partial spectral ranges are arranged according to a predetermined condition, e.g., according to their sizes. The sequence of partial spectral ranges thus obtained is compared to prestored sequences characteristic of the consumables. As an alternative to said evaluation method, the measured values for partial spectral ranges can be compared to threshold values or reference measured value ranges prestored for the consumables and the best congruence can be determined. It is advantageous to determine the prestored sequences or threshold values or reference measured value ranges, respectively, by calibration measurements.

In a further embodiment of the device according to the invention which is equipped with optical and/or infrared detectors as mentioned above and an evaluation unit, the evaluation unit communicates with a radio transmitter for transmitting the evaluation results to a remote aircraft surveillance service. Also in this embodiment of the invention, it is appropriate to transmit the evaluation results supplemented by time and date information as well as optionally by identification information about the aircraft, the pilot and/or the measuring device. The aircraft surveillance service may, for example, be a central technical service of the airline operating the aircraft. The data received by the aircraft surveillance service are stored centrally while being allocated to the aircraft so that a looming technical defect can be inferred from repeated messages about a leakage of consumables from a specific aircraft at an early stage and arrangements can be made for a repair. It is likewise possible to query said data during routine maintenance work in the hangar, thus directing the inspection specifically to possible problem areas of the aircraft.

In order to run the analytical reactions reliably and with a quick conversion into detection results, it is useful if at least one detection unit comprises pretreatment zones which serve for the pretreatment and conversion of the consumable.

The invention is now illustrated in further detail with reference to the drawing, based on exemplary embodiments to which the invention is not restricted, however.

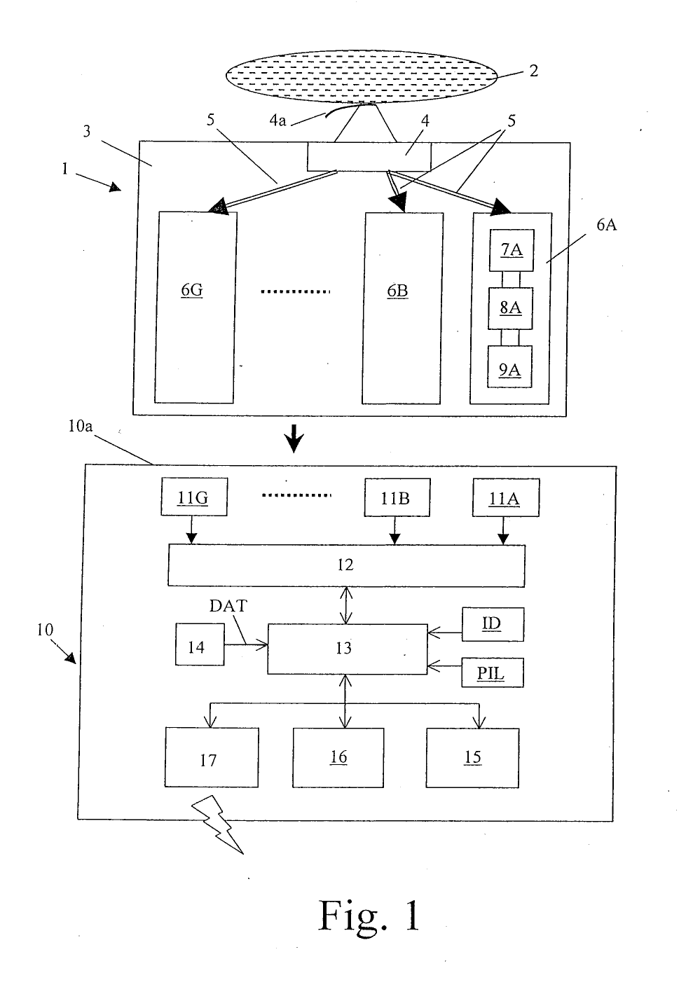

FIG. 1 shows a block diagram of a first embodiment of a device according to the invention for distinguishing between aircraft consumables using colour-chemical reactions.

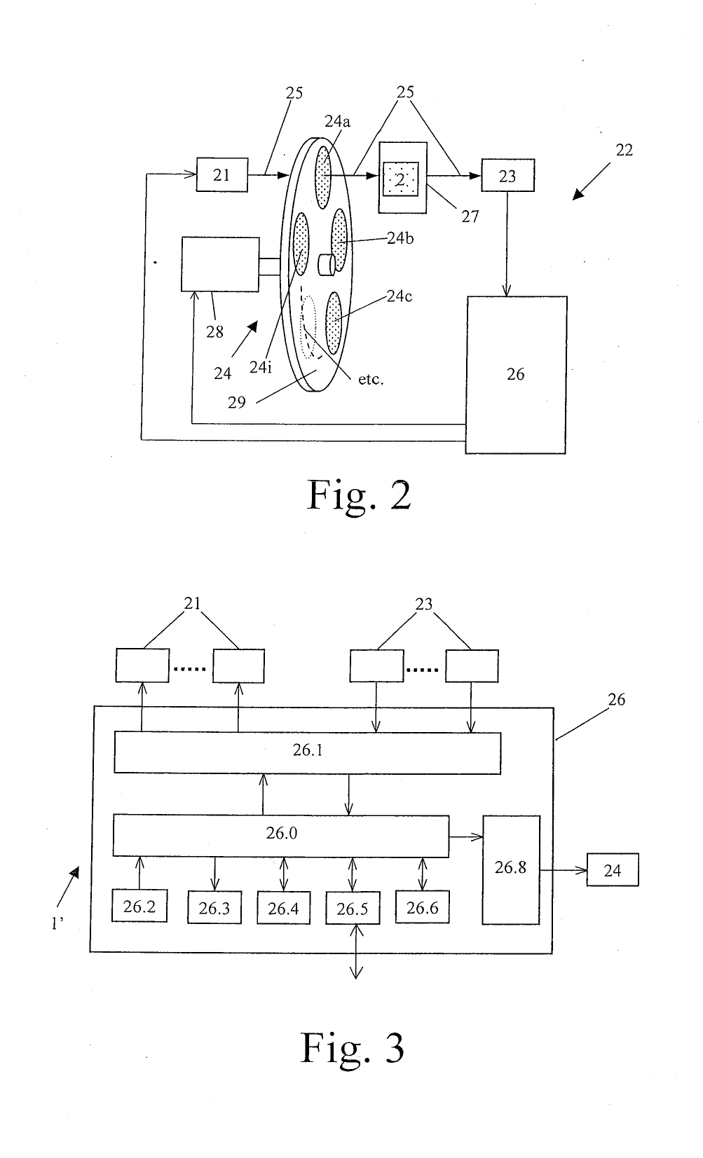

FIG. 2 shows a block diagram of a second embodiment of a device according to the invention for distinguishing between aircraft consumables with infrared sensors.

FIG. 3 shows a block diagram of an evaluation and control unit used in the second embodiment.

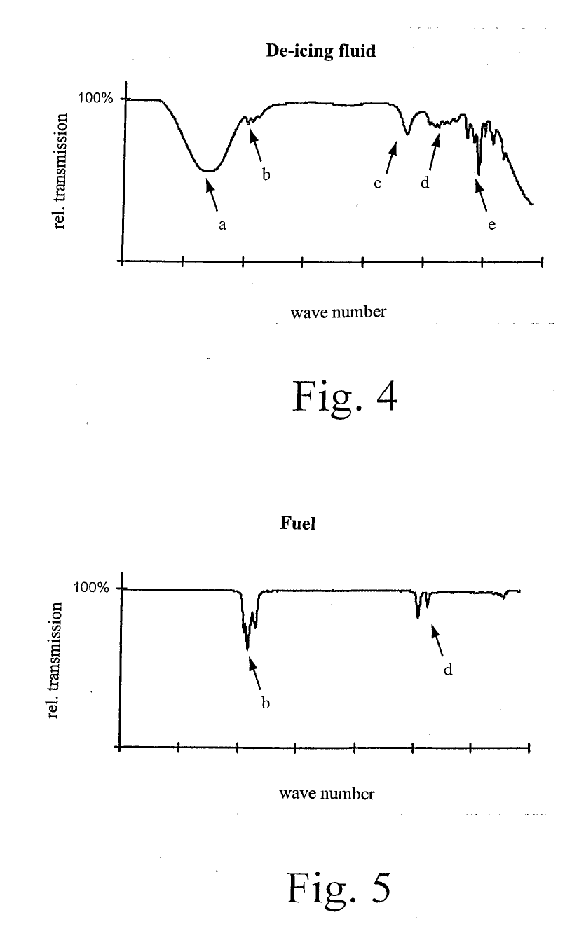

FIG. 4 shows a diagram of an infrared spectrum characteristic of de-icing fluid.

FIG. 5 shows a diagram of an infrared spectrum characteristic of fuel.

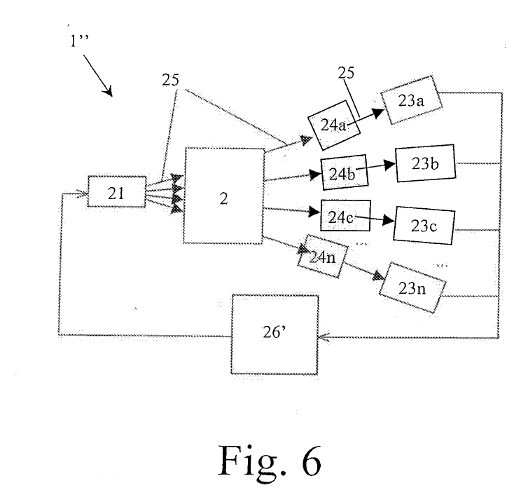

FIG. 6 shows a block diagram of a further embodiment of a device according to the invention for distinguishing between aircraft consumables.

In the following, the device according to the invention for distinguishing between consumables is exemplified based on two embodiments, wherein the two embodiments are implemented separately from each other or in combination in one handset. The variant of the invention designed as the first embodiment, which is schematically illustrated in the block diagram of FIG. 1, is based on chemical colour reactions, preferably on test strips, for distinguishing between aircraft consumables. The second variant of the device according to the invention as schematically illustrated in FIGS. 2 and 3 is based on infrared sensors and infrared technology, respectively. Combinations of the two embodiments may be designed either such that specific aircraft consumables are detected according to the first variant and other aircraft consumables are detected according to the second variant or such that one variant is used for the verification of detection results which were obtained using the other variant.

To beging with, the first embodiment of a device 1 according to the invention is exemplified on the basis of FIG. 1 with regard to the detection of de-icing fluid, which may, for example, be the commonly used products Safewing MP I 1938 TF or Aircraft De-Icer. FIG. 1 schematically shows the device 1 according to the invention for distinguishing between aircraft consumables 2, which comprise aircraft fuel (kerosene), de-icing fluid, turbine oil, hydraulic oil, pneumatic oil, propeller grease for adjustable rotor blades and lubricating greases. The device 1 comprises a carrier 3 made, e.g., of a synthetic material, on which respective detection units 6A, 6B to 6G are provided for each aircraft consumable 2 to be detected. The device 1 according to the invention for detecting aircraft consumables 2 is preferably designed as a test strip, in particular as a multitest strip. Each detection unit 6A to 6G may comprise two or more zones which serve for the pretreatment and conversion of the consumables 2 to be detected. By way of illustration, a pretreatment zone 7A, an intermediate treatment zone 8A and a detection zone 9A are shown in the detection unit 6A. An intake area 4 for receiving a sample of an aircraft consumable 2 to be identified is arranged upstream of the detection units 6A to 6G on the carrier 3, whereby the aircraft consumable 2 received is transferred from the intake area 4 to each detection unit 6A to 6G. The aircraft consumables 2 to be detected are generally provided in a liquid or highly viscous form. It is therefore useful to design the intake area 4 in such a way that it will suck in the aircraft consumable 2. This can be done by forming capillaries or providing an absorbent material in the intake area 4. However, in one variant of the invention, it is also provided that the intake area 4 is designed as a small evacuated container having a suction opening which is sealed by a protective film 4a or the like. When using the device 1, the suction opening is held into a sample of the aircraft consumable 2 to be identified and the protective film 4a is pulled off so that the sample can be sucked into the intake area 4. If the device 1 is designed as a test strip, the test strip is contacted with the consumable, whereupon a chemical colour reaction as described below will set in, which can be evaluated after approximately 2 minutes. The device 1 according to the invention for distinguishing between aircraft consumables 2 thus functions as a quick test which provides the result on site.

In case the consumable 2 to be identified is provided in a highly viscous form with too little fluid content so that suction is not possible, the intake area 4 can also be designed for spreading on a sample of the consumable 2. For such cases, the intake area 4 is possibly heatable in order to bring the consumable 2 into a sufficiently low-viscous or liquid state, or is provided with a reservoir of diluting fluid which is mixed with the applied sample in the intake area 4, thus bringing said sample into a liquid state.

The intake area 4 is connected to all detection units 6A to 6G via conduits 5, with the conduits 5 in each case introducing a portion of the sample of the aircraft consumable 2 into each detection unit 6A to 6G by capillary action or by an absorbent material or by previous evacuation, where it is then subjected to a selective analytical reaction in the form of a colour-chemical reaction, i.e., each detection unit reacts to a specific aircraft consumable 2. The analytical reactions in the detection units are thereby chosen such that they provide results which are visually or optically, in particular optoelectronically, analyzable.

Below, an analytical reaction for glycol-containing de-icing fluid as an aircraft consumable is illustrated. Such a de-icing fluid drips down from aircraft relatively often, but is harmless and does not in any way interfere with the air traffic. The de-icing fluid is drawn at first into the intake area 4 and from there, via conduit 5, into the detection unit 6A. As mentioned above, the detection unit 6A comprises three zones, namely a pretreatment zone 7A, an intermediate treatment zone 8A and a detection zone 9A. In the event of glycol-containing de-icing fluid being detected, the pretreatment zone 7A is designed as an oxidation zone which contains sodium periodate, potassium periodate, sodium dichromate, potassium dichromate or the like in order to break down the glycol in the de-icing fluid so that aldehydes, in particular formaldehyde and acetaldehyde, will form. The intermediate treatment zone 8A adjacent to the pretreatment zone 7A is designed as an alkalization zone which contains a small amount of sodium base liquor or the like in order to bring the aldehyde formed in the oxidation zone into an alkaline environment. Next to the intermediate treatment zone 8A, the detection zone 9A is located, which contains Purpald® which forms an unstable aminal with the carbonyl group of an aldehyde in an alkaline environment, whereby dehydration occurs. Said aminal is oxidized by oxygen into a yellow product which forms a purple anion in an alkaline environment. The purple colouration of Purpald®, which is present as a white powder prior to the reaction with the aldehyde, represents a detection of glycol-containing de-icing fluid which is visually clear to any user of the device according to the invention. The reaction takes only about 1 to 2 minutes until the Purpald turns purple. In said embodiment, the device 1 according to the invention is thus able in many cases to prevent delays in departure of aircraft, since the pilot can determine very quickly that the liquid leaked from his aircraft is harmless de-icing fluid. It should be mentioned once again that a quantitative measurement of the consumable is generally not required.

An evaluation and control unit 10, which is either embedded in the device 1 or can be coupled thereto, is provided for the objective evaluation of the colour-chemical analytical reactions of aircraft consumables in the detection units 6A to 6G. If the device 1 and the evaluation and control unit 10 are designed as separate assembly groups, which can be coupled to each other, the device 1 is inserted into the evaluation and control unit 10 either prior to the startup or upon completion of a colour-chemical analytical reaction of an aircraft consumable 2 by pushing the carrier 3 into a slot 10a along guides (not illustrated) until the detection units 6A to 6G are effectively connected to optical, in particular optoelectronic, detectors 11A to 11G allocated to a respective detection unit. The signals supplied by the detectors 11A to 11G are processed by a signal processing circuit 12, which determines for each detection unit 6A to 6G as to whether an analytical reaction of a specific aircraft consumable has occurred by finding out whether the signals supplied by detectors 11A to 11G fall within predetermined values or, however, are above or below predetermined threshold values. During the analytical reaction for identifying de-icing fluid as described above, the detector 11A allocated to the detection unit 6A can detect the discolouration of Purpald in a, for example, reflectometric manner. The data on the existence or non-existence of particular aircraft consumables 2 established by the signal processing circuit 12 are transferred to a microprocessor 13 which links them to time and date information DAT from a timer 14 as well as optionally to identification information PIL about the user of the control and evaluation unit 10 or of the device 1, respectively, and files them in a nonvolatile memory 15 so that a long-term data protocol retrievable at any time will be available. Furthermore, the result of the detection of a consumable is shown on a display 16.

In addition, the data on the existence or non-existence of particular aircraft consumables 2 established by the signal processing circuit 12 can be transferred to a remote aircraft surveillance service via a radio transmitter 17. In doing so, it is also useful to transmit the evaluation results with the time and date information DAT, as well as optionally with the identification information PIL about the user, possibly with identification information about the aircraft and identification information ID about the measuring device.

Based on FIGS. 2 and 3, a second embodiment of a device 1′ according to the invention for distinguishing between aircraft consumables 2, which is based on infrared technology, is now illustrated. Said embodiment of the invention is perfectly suitable for the differentiation of kerosene (e.g. Jet A1), gas turbine oil and jet engine oil (e.g. Mobil Jet Oil II), respectively, hydraulic oil (e.g. Exxon HyJet IV-Aplus and AeroShell Fluid 41) and pneumatic oil, lubricating greases, de-icing fluid, respectively.

Kerosene is a mixture of aliphatic and aromatic hydrocarbons accumulating as a fraction from atmospheric crude oil distillation at between approx. 175 and 225° C. Kerosene used as an aviation fuel is referred to as Jet A1. Additives in ppm-amounts are added for the adjustment of important properties—such as, e.g., a minimum of electrical conductivity.

Lubricating oils (gas turbine oil, hydraulic oil, pneumatic oil) are composed of base oils and additives. Besides base oils and additives, lubricating greases also contain thickening additives which bring about the fatty consistency. By means of additives, properties can be adjusted or attenuated, respectively, which base oils do not exhibit at all or only to a small extent or which are unwanted for the application, respectively. Usually, these are antiwear and anticorrosive additives, antioxidants, antifoaming agents, detergents and dispersants, etc. The high safety requirements in aviation generally require the use of lubricating oils having a high thermal stability and, in particular, a flame-retardant effect. This can be a reason for the use of phosphoric acid esters.

Common aircraft consumables can be distinguished based on differences in their spectra in the medium infrared range. Those spectral differences between aircraft consumables are particularly characteristic in certain spectral ranges of the spectrum. Thus, a differentiation of aircraft consumables, in particular in the spectral ranges a, b, c, d and e, optionally also in appropriately chosen subranges, is possible. The accuracy of distinguishing between aircraft consumables can be increased by refining the spectral ranges.

The restriction of the measurement to individual, preferably at least three, characteristic bands in the medium infrared spectrum (4000 cm⁻¹ to 400 cm⁻¹) permits a significantly simpler, cheaper and also smaller implementation of the device. Those advantages allow a design as a mobile handset, whereby on-site analysis is rendered possible and time can be saved, which is important for the air traffic.

As schematically illustrated in FIG. 2 and FIG. 3, the device 1′ according to the invention comprises one or several detection units 22 comprising the following components: one or several infrared sources 21 emit infrared light in a suitable wavelength range. The infrared light shines on or through the sample of a consumable 2 processed in an appropriate form, is thereby attenuated in a substance-specific manner and is then directed to one or several infrared detectors 23 which are sensitive to the wavelength ranges to be measured. If required, the wavelength ranges to be examined are selected by suitable infrared filters 24 (see FIG. 2). Alternatively, the selection of the wavelength ranges may also occur after the light has shone on or through the sample of consumable 2 to be determined in front of the infrared detector 23. The preparation of the consumables 2 is preferably performed in a suitable sample intake 27 which exhibits a sample thickness of the medium to be examined which is necessary for an adequate attenuation.

FIG. 3 shows an evaluation and control unit 26 of the device 1′. An analog electronic system 26.1 suitable for the operation of the infrared sources 21 and the signal processing of the infrared detectors 23 for implementing the measurements is actuated by a microcontroller 26.0. The microcontroller 26.0 simultaneously processes the measuring signals of the infrared detectors 23, which signals have been prepared by the analog electronic system 26.1. For the design variant illustrated in FIG. 1, an electronic interface 26.8 is provided for actuating the device 28 in order to activate the spectral filters 24a to 24i by means of the microcontroller 26.0. The evaluation and control unit 26 furthermore comprises an input unit (keyboard) 26.2, an indicating unit (display) 26.3, a timer with time and date information 26.4, a nonvolatile data memory 26.5 and an interface module 26.6.

Specific reference is now made to FIG. 2. The infrared light emitted by the infrared source 21 in a broadband manner is selectively filtered by a filter generally indicated by reference numeral 24. The filter 24 comprises a rotatable base support 29 on which a number of spectral filter disks 24a to 24i (i stands for a random number) are arranged, which have different filter wavelength ranges. Using a device 28 for activating the spectral filter disks, those spectral filter disks 24a to 24i are sequentially switched into the optical path of the infrared beam of light 25 between the infrared source 21 and the infrared detector 23, ahead of or after an optical sample interface 27, whereby the infrared beam 25 is filtered through the infrared spectral filters 24a to 24i. The optical sample interface 27 housed in the optical path of the infrared beam of light 25 between the infrared source 21 and the infrared detector 23 allows interaction of the infrared beam of light 25 with the sample of consumable 2. The evaluation and control unit 26 actuates the infrared source 21, processes the signals of the infrared detector 23 and actuates the device 28 for activating the filters in a coordinated manner, for the sequential measurement in the bands determined by the infrared spectral filters 24a to 24i. Thereby, the optical sample interface 27 can be designed such that the infrared beam of light 25 shines all through the sample 2 (having a thickness of preferably between 0.01 mm and 10 mm). Alternatively, the optical sample interface 27 can be designed in a reflectometric manner, making use of the inner or outer reflection.

The suggested measuring arrangement provides infrared spectral filters 24a to 24i for several, preferably at least three, defined band widths, which select the spectral ranges of the infrared spectrum which are important for distinguishing between aircraft consumables, preferably the spectral ranges a, b, c, d, and e, for the measurement, and thus enable the use of low-priced infrared sources 21 and infrared detectors 23, which are broadband in the medium infrared.

Table 1 shows the suggested IR-spectral ranges for infrared filters 24a to 24e, which are preferably used for distinguishing between aircraft consumables. At least three IR-spectral ranges are provided for distinguishing between aircraft consumables.

TABLE 1

Spectral range

| | from | to |
|---|---|---|
| Filter | [cm⁻¹] | [cm⁻¹] |
| a | 3700 | 3020 |
| b | 3000 | 2820 |
| c | 1800 | 1560 |
| d | 1500 | 1200 |
| e | 1175 | 890 |

Table 2 exemplifies different aircraft consumables and the IR-spectral ranges from Table 1 which are usable for the differentiation thereof. It must be pointed out that pneumatic oil is mostly based on a hydraulic oil, but has a different consistency. In said exemplary embodiment, the pneumatic oil is equivalent, e.g., to hydraulic oil 1.

TABLE 2

| Aircraft consumable | Sequence of |
|---|---|
| Denomination | measured quantities |
| Fuel/kerosene | b, d |
| Turbine oil | e, d, b |
| Hydraulic oil 1 | e, b, d |
| Hydraulic oil 2 | b, e, d |
| Pneumatic oil | e.g. hydraulic oil 1 |
| Lubricating grease 1 | e, b, d, c |
| Lubricating grease 2 | b, e, d, c |
| De-icing fluid | a, e, d, b, c |
| Water | a, c, e, d |

In one design variant, the evaluation of the measurements can be performed by arranging the measured values for at least three of the IR-spectral ranges according to the size (as illustrated in Table 2) and comparing the sequence thus determined to the sequences prestored for the currently used aircraft consumables. The prestored sequences are determined similarly for the aircraft consumables used by calibration measurements performed in the time intervals which are considered reasonable therefor.

In another design variant, the evaluation can be performed by comparing the measured values for at least three of the IR-spectral ranges to the threshold values prestored for the currently used aircraft consumables and by determining the best congruence. The prestored threshold values are determined for the currently used aircraft consumables by calibration measurements performed in the time intervals which are considered reasonable therefor.

FIG. 4 and FIG. 5 exemplify infrared spectra of the two most common aircraft consumables, which are indeed identified in a majority of cases where an identification is necessary. FIG. 4 shows the infrared spectrum of a commercially available de-icing fluid. The characteristic spectral ranges are marked by arrows a to e, the allocation of the IR-spectral ranges which are preferably usable for the differentiation can be seen in Table 1. FIG. 5 shows the infrared spectrum for aircraft fuel. The characteristic spectral ranges are marked by arrows b and d, the allocation of the IR-spectral ranges which are preferably usable for the differentiation can be seen in Table 1.

FIG. 6 shows a block diagram of a further embodiment of a device 1″ according to the invention for distinguishing between aircraft consumables. The device 1″ comprises an infrared source 21 which radiates IR-light through an optical path 25 onto a sample 2 of the aircraft consumable. The IR-light portions passing through the sample 2 are directed via further optical paths 25 to spectral filters 24a, 24b, 24c . . . 24n, which have different filter frequencies. The IR-light portions let through by the spectral filters are directed via further optical paths 25 to IR-detectors 23a, 23b, 23c . . . 23n, the output signals of which are evaluated by an evaluation and control unit 26′ and which permit the differentiation of the aircraft consumables of sample 2, as explained above based on FIGS. 4 and 5.

The device 1″ according to the invention is structurally similar to the device 1 comprising the evaluation and control unit 10 of FIG. 1, wherein, in the embodiment of FIG. 6, the detection and evaluation is performed on the basis of infrared spectroscopy and, in the embodiment of FIG. 1, the optical detection of a colour-chemical reaction is accomplished by a detection and evaluation of the optical properties of the colour-chemical reaction (in particular a change in colour).

1. A device for distinguishing between aircraft consumables, wherein the device is portable and designed as a handset and comprises at least one detection unit designed for detecting at least one aircraft consumable, the aircraft consumables comprising fuel, de-icing fluid, turbine oil, hydraulic oil, pneumatic oil and/or propeller grease for adjustable rotor blades and lubricating greases.

2. A device according to claim 1, wherein it is designed as a quick-test device which provides the discrimination result on site.

3. A device according to claim 1, wherein an intake area receives a sample of an aircraft consumable, with the intake area forwarding the sample to the at least one detection unit by means of capillaries or vacuum conduits.

4. A device according to claim 1, wherein at least one detection unit is based on colour-chemical reactions to aircraft consumables.

5. A device according to claim 4, wherein the detection unit comprises a carrier impregnated with at least one substance which produces a colour-chemical analytical reaction upon contact with a consumable, with the carrier optionally being applied to an inert substrate or at least another carrier impregnated with a said substance.

6. A device according to claim 5, wherein the detection unit is designed as a test strip.

7. A device according to claim 4, wherein an optical, in particular optoelectronic, detector is provided for the detection of the colour-chemical reaction.

8. A device according to claim 3, wherein a detection unit is designed for the detection of glycol-containing de-icing fluid and preferably comprises an oxidation zone preferably impregnated with sodium periodate, potassium periodate, sodium dichromate or potassium dichromate, an alkalization zone preferably impregnated with caustic soda or caustic potash solution, and a detection zone impregnated with Purpald®.

9. A device according to claim 1, wherein the detection unit comprises infrared sensors for distinguishing between aircraft consumables.

10. A device according to claim 9, wherein the infrared sensors comprise an infrared source, an infrared detector and a consumable sample interface (27) arranged in the optical path between the infrared source and the infrared detector, with the infrared source radiating broadband infrared light onto the sample interface and the infrared detector detecting the infrared light after interaction with the consumable sample.

11. A device according to claim 9, wherein infrared spectral filters are switchable into the optical path between the infrared source and the sample interface.

12. A device according to claim 11, wherein the infrared spectral filters are sequentially switchable into the optical path.

13. A device according to claim 10, wherein an evaluation and control unit evaluates the signals of the infrared detector.

14. A device according to claim 13, wherein the evaluation and control unit evaluates at least two, preferably at least three, characteristic partial spectral ranges of the spectrum receivable by the infrared detector.

15. A device according to claim 14, wherein the evaluation and control unit switches infrared spectral filters with filter frequency ranges according to the characteristic partial spectral ranges into the optical path and, in each case, evaluates the partial spectrum received by the infrared detector.

16. A device according to claim 14, wherein the measured values for partial spectral ranges are arranged according to a predetermined condition, and the sequence of partial spectral ranges thus obtained is compared to prestored sequences characteristic of the consumables.

17. A device according to claim 14, wherein the measured values for partial spectral ranges are compared to threshold values or reference measured value ranges prestored for the consumables and the best congruence is determined.

18. A device according to claim 16, wherein the prestored sequences or threshold values or reference measured value ranges, respectively, are determined by calibration measurements.

19. A device according to claim 1, wherein a control and evaluation unit has a nonvolatile data memory for recording the evaluation results, preferably supplemented by time and date information as well as optionally by identification information about the aircraft and/or the pilot.

20. A device according to claim 19, wherein the evaluation unit has a radio transmitter and/or an interface module for transmitting the evaluation results to a remote aircraft surveillance service, preferably supplemented by time and date information as well as optionally by identification information about the aircraft, the pilot and/or the evaluation unit or device, respectively.

21. A device according to claim 1, wherein at least one detection unit comprises treatment zones for the pretreatment and intermediate treatment and conversion, respectively, of the consumable.

22. A device according to claim 4, wherein the characteristic partial spectral ranges are selected from:
Spectral range

| | from | to |
|---|---|---|
| Partial spectral range | [cm⁻¹] | [cm⁻¹] |
| a | 3700 | 3020 |
| b | 3000 | 2820 |
| c | 1800 | 1560 |
| d | 1500 | 1200 |
| e | 1175 | 890 |

23. A device according to claim 16, wherein the predetermined condition includes an arrangement according to size.
